(19) United States
(12) Patent Application Publication
(10) Pub. No.: US 2017/0036890 A1
(43) Pub. Date: Feb. 9, 2017

(54) GUIDE RAIL ARRANGEMENT AND METHOD FOR INSTALLING GUIDE RAILS

(71) Applicant: KONE Corporation, Helsinki (FI)

(72) Inventor: Mikael HAAG, Vantaa (FI)

(73) Assignee: KONE Corporation, Helsinki (FI)

(21) Appl. No.: 15/203,507

(22) Filed: Jul. 6, 2016

(30) Foreign Application Priority Data
Aug. 7, 2015 (EP) 15180203

(51) Int. Cl. B66B 7/02; B66B 19/00

(52) U.S. Cl. CPC B66B 7/026; B66B 7/02; B66B 19/002

(57) ABSTRACT

A guide rail arrangement for an elevator shaft includes two guide rails guiding the movement of an elevator car or a counterweight. Each guide rail guides the movement of a different elevator car or counterweight, the guide rails are connected to each other by a plurality of connector beams positioned along the length of the guide rails and each connector beam has two ends. Each end of a connector beam is attached to one guide rail for connecting the guide rails to each other and for rigidifying the guide rails. A method for installing guide rails in an elevator shaft and an elevator arrangement are also disclosed.

### TECHNICAL FIELD

The present disclosure relates to a guide rail arrangement, to a method for installing guide rails in an elevator shaft and to an elevator arrangement.

### BACKGROUND ART

Guide rails are used to guide the vertical movement of an elevator car in an elevator shaft. Usually there are two guide rails on the opposite sides of the elevator car, which is linked to the guide rails through guide shoes or guide rollers facing the guide rails. Guide rails are constructed from multiple guide rail sections that are connected to each other from their vertical ends to form a continuous guiding structure for the elevator car. In elevator shafts intended for only one elevator car, the guide rails are usually attached to the walls of the elevator shaft through brackets.

However, in larger buildings there are often several elevators working in parallel in a shared elevator shaft, each elevator having its own elevator car and corresponding guide rails. In these cases, the guide rails not positioned next to an elevator shaft wall are supported by so-called dividing beams. The dividing beams are horizontal beams placed between two adjacent elevators and attached from their both ends to the walls of the elevator shaft or to other strong structures. The guide rails are attached to the dividing beams through brackets.

Guide rail sections are usually several meters in length and made of steel. They are thus heavy and their handling during installation requires caution. Further, the weight of the completed guide rails is proportional to their length, and the higher the elevator shaft, the longer guide rails are needed. Consequently, the guide rails can become very heavy, weighing in the range of several tonnes. This, in turn is reflected in the design of the dividing beams, which have to be strong enough and located densely enough to provide appropriate support for the guide rails.

If the elevator is equipped with a counterweight, it most commonly runs along its own guide rails. The counterweight guide rails have a similar structure as the elevator car guide rails, but they are usually located closer to each other.

As the elevator car or guide rail runs along the guide rails, the shaking, uneven movement and noise should be minimized in order to optimize ride comfort and to reduce wearing of the elevator components. Therefore, the straightness of the guide rails is important. The guide rails need to be rigid enough not to be bent by the pressure exerted on them by the elevator car or counterweight supporting itself on them. Further, the guide rails need to withstand the changes in the building dimensions that inevitably take place, especially in new buildings. New buildings tend to slightly “shrink” vertically during the first months and years after their construction and this is reflected in the tensions exerted on the guide rails.

Guide rails are typically installed in the elevator shaft in a bottom-up manner. The vertical line in which each guide rail should run is first established. Then, the two bottom-most guide rail sections of a given pair of guide rails guiding an elevator car or a counterweight are then attached to the walls or dividing beams through brackets. The straightness of the guide rail sections is checked and adjusted through the brackets if necessary. Then, the next pair of guide rail sections is mounted on top of the first pair and attached to the wall as the previous guide rail sections. The straightness of the guide rail sections is checked in relation to the guide rail section below and adjusted through the brackets if necessary.

Drawbacks of the current solutions are that the guide rails, especially for elevators with long hoisting distances, are heavy and difficult to move and to install. This increases the transportation and installation costs. During installation, the work is slowed down due to the bulkiness of the guide rails. Further, the guide rail material costs are proportional to the heaviness of the guide rails.

The inventors have thus recognized the need for reducing the weight of guide rails while retaining their rigidity.

### SUMMARY

An objective of the present disclosure is to alleviate at least one of the problems associated with prior art solutions. Especially, it is the objective of the present disclosure to allow the construction of a lighter guide rail while retaining sufficient guide rail rigidity. Conversely, it is the objective of the present disclosure to increase the rigidity of guide rails without increasing their weight.

The present guide rail arrangement and the method for installing an elevator are in particular, but not only, intended for elevators, especially for passenger or cargo elevators of buildings.

By an elevator is herein meant a device intended for moving an elevator car. An elevator comprises an elevator car, elevator car guide rails, an optional counterweight and counterweight guide rails, a hoisting system form moving the elevator car and the optional counterweight, and all the necessary equipment for appropriately running the elevator car and optionally coordinating its function with other elevators present in the same elevator installation. The elevator can be, for example, a passenger elevator or a cargo elevator. Typically, some elevator components are located within the elevator shaft, while some components are located outside the elevator shaft.

The guide rail arrangement according to the present disclosure is characterized by what is presented in claim 1.

The method for installing guide rails according to the present disclosure is characterized by what is presented in claim 12.

The elevator arrangement according to the present disclosure is characterized by what is presented in claim 14.

The guide rail arrangement according to the present disclosure and the method for installing guide rails can offer at least one of the following advantages over prior art.

An advantage is that a guide rail with a narrower profile can be constructed to achieve the desired rigidity of the guide rail. This may save material and transportation costs. The installation of lighter guide rail sections may be faster and safer. Conversely, a guide rail with a given thickness may be more rigid than prior-art guide rails.

Another advantage is that the number of dividing beams may be reduced. This is because sufficient support the guide rails according to the present disclosure can be achieved with increased intervals of the dividing beams. This might speed up the installation work of the guide rails. It might further be possible to use thinner dividing beams to support the guide rail arrangements according to the present disclosure. These advantages might contribute to material savings on the dividing beams.

Further, the more elevators there are running in a shared elevator shaft, the more pronounced the benefits of the current arrangement might become. Typically, more elevatoring capacity is needed in larger buildings, which is often reflected in the height and heaviness of the guide rails.

### BRIEF DESCRIPTION OF DRAWINGS

The accompanying drawings, which are included to provide a further understanding of the disclosure and constitute a part of this specification, illustrate embodiments and together with the description help to explain the principles of the disclosure but the disclosure is not limited to the specific embodiments illustrated in the drawings. In the drawings:

FIG. 1A is a schematic overview of an elevator arrangement from above.

FIG. 1B is a schematic overview of an elevator arrangement from one side comprising the guide rail arrangement according to the present disclosure.

FIG. 2, panels A to G, presents embodiments of the guide rail arrangement according to the present disclosure viewed from the side.

FIG. 3, panels A-D, presents embodiments of the guide rail arrangement according to the present disclosure viewed along the length of the guide rails.

### DETAILED DESCRIPTION

In one aspect, a guide rail arrangement for an elevator shaft is disclosed. The guide rail arrangement comprises two guide rails guiding the movement of an elevator car or a counterweight, each guide rail guiding the movement of a different elevator car or counterweight. The guide rails are connected to each other by a plurality of connector beams positioned along the length of the guide rails, each connector beam having two ends. The guide rail arrangement is characterized in that each end of a connector beam is attached to one guide rail for connecting the guide rails to each other and for rigidifying the guide rails.

In the guide rail arrangement according to the present disclosure, two guide rails are connected by several connector beams. The guide rails can be connected by three or more connector beams. The connector beams extend between the two guide rails and are fastened from their ends to the guide rails. Each connector beam has a first end and a second end. The first end of each connector beam is attached to one guide rail and the second end of each connector beam is attached to a second guide rail. The connector beam is typically substantially straight.

The structure that results is advantageously more rigid than each of the guide rails alone. The two guide rails are connected to form a continuous structure. Especially, the bending of the guide rails may be reduced. The connector beams are located along the length of the guide rails so that they lend support to the guide rails. In many embodiments, the connector beams are distributed along a substantial portion of the guide rail length. The substantial portion of guide rail length may be, for example at least 50% or 70% of the guide rail length. There are many different ways to design the positioning, geometry, strength, material and number of the connector beams. If the two guide rails to be connected by the connector beam are close to each other and a thick connector beam is used, the connector beam can resemble a block.

The guide rail arrangement according to the present disclosure is located in an elevator shaft. By an elevator shaft is herein meant the space in which at least two elevator cars move vertically. The optional counterweights may also move in the elevator shaft. The elevator shaft can have closed walls. The walls can be made of any material or a combination of materials known in the art, such as glass, steel or stone. The elevator shaft can alternatively be at least partially open. It is possible that the elevator shaft comprises only a supporting frame for the elevator and is separated from the structures of the building the elevator serves.

The guide rail arrangement according to the present disclosure can be used in elevators with or without a counterweight. In cases where a counterweight is not present, the current arrangement is used for elevator car guide rails. In cases where a counterweight is present, the current arrangement can be used for counterweight guide rails or elevator car guide rails or for both.

In embodiments in which two elevator car guide rails are connected in the current guide rail arrangement, the two guide rails guide the movement of two different elevator cars. In embodiments in which two counterweight guide rails are connected in the current guide rail arrangement, the two guide rails guide the movement of two different counterweights. In other words, the guide rails in the current guide rail arrangement belong to different elevators.

When a guide rail arrangement according to the present disclosure is used, a lighter-structured guide rail can be constructed to achieve a given rigidity of the guide rails.

By a guide rail herein is meant a continuous rail that guides the substantially vertical movement of an elevator car or a counterweight in an elevator shaft. The guide rail for the counterweight is termed a counterweight guide rail. The guide rail for the elevator car is termed an elevator car guide rail. Typically guide rails are used as pairs, so that there is one guide rail on two opposite sides of the counterweight and/or the elevator car. Especially the counterweight can only have one guide rail.

Guide rails are usually made of steel, although other materials might be suitable. The material and exact dimensions depend on the specific application for which the guide rail sections are used.

The guide rail in the meaning of the current disclosure does not need to be completed. The guide rail comprises several guide rail sections that form the guide rail. By a guide rail section is herein meant a section of a guide rail that is attachable or attached from its one end to an adjacent guide rail section or from its both ends to two adjacent guide rail sections. When at least one guide rail section is mounted in the elevator shaft, it can be said to form a guide rail.

Guide rail sections are usually several meters in length, a length of 5 m being typical. They also vary in their width in different elevator constructions, but can have a width of, for example, 127 mm. The width and thickness of the guide rail sections depends on the elevator application in question.

The distance between the two guide rails is typically approximately 300 mm. However, the distance depends on the dimensions of the elevator shaft and the elevators in the elevator shafts. Distance of 150-250 mm is possible. Also larger distances, for example, approximately 400 mm or 600 mm are possible.

The connector beams are positioned along the length of the guide rails. The connector beams can be evenly distributed along the length of the guide rails. In other words, the distance between the adjacent connector beams may be substantially constant. However, in some embodiments, the connector beams can be grouped. This means that there are two or more connector beams that are close to each other and the distance to the next connector beam outside the group is larger. For example, the distance can be approximately two, three or five times as large as between the adjacent connector beams in a group.

The distance between the two connector beams is counted as the distance in the direction of the guide rail length being the shortest. For example, it is possible that the connector beams form a “zigzag” pattern when viewed from the side. In such a case, the distance between the adjacent connector beams is counted as the distance between the ends of the adjacent connector beams that are attached to the same guide rail and are closest to each other in the direction of the guide rail length.

The connector beams being close to each other means, for example, that the distance between two adjacent connector beams is less than 5 cm. It can alternatively mean that the distance is less than 10 cm. A further alternative of two adjacent connector beams being relatively close to each other is that the distance between them is less than 50 cm.

The connector beams can be used together with the dividing beams for achieving a rigidified guide rail arrangement. Often, the dividing beams are permanently fixed to the elevator shaft structures from their ends. They have a length of, for example 2 to 3 m and each dividing beam can weigh hundreds of kilograms. Shorter or longer dividing beams are possible. The length of a dividing beam depends on the elevator shaft dimensions, which is, in turn, affected by the elevator car size and the positioning and shape of the counterweight. The dividing beams are typically made of steel and have an I-profile (also known as double-T-profile). In such a case, the web portion of the dividing beam is substantially vertical. If the web portion of a double-T-profiled dividing beam is substantially horizontal, it is most commonly termed H-profile. Such a configuration is also possible. Additionally, other profiles known in the art, such as L-, U- and C-profiles are possible. In some applications, a flat profile is possible.

The thickness of the dividing beam depends on its required strength and profile. There is no upper limit for the thickness of the dividing beam, as it depends on the sturdiness of the dividing beam, which is proportional to the hoisting distance and size of the elevator components. If a double-T-profiled dividing beam is used, its width (i.e width of the flanges) can be, for example 200 mm. Narrower and wider widths of, for example 100 to 500 mm, are possible. The height (i.e. the width of the web plus the thickness of the flanges) of a double-T-profiled dividing beam can be, for example 260 mm. Also this measure varies depending on the elevator characteristics. It can be, for example, 150 to 700 mm.

The attachment between a dividing beam and the guide rail is in many cases adjustable. In most cases, the guide rails are attached to the dividing beams by brackets. The connection between a bracket and a guide rail or a dividing beam can be established by bolts passing corresponding openings in the dividing beam, guide rail and the bracket. Alternatively, the bracket can be nailed to the guide rail and/or to the dividing beam. Alternatively, the bracket can be welded to the guide rail and/or to the dividing beam. The different methods of attaching the guide rail and the dividing beam to the bracket can be the same or different for a given bracket. For example, the bracket can be welded to the dividing beam, but bolt attachment can be used for the guide rail.

Each dividing beams offers a point of support between the two guide rails. Therefore, it is possible that some distance is left between the dividing beam and the connector beam being closest to the dividing beam in either direction along the length of the guide rail. Due to the added support of the connector beams in the current guide rail arrangement, it might be possible to install the guide rails with a fewer number of dividing beams compared to prior art solutions.

Typically, the connector beams are mounted in the middle of the cross sectional profile of each guide rail. However, it is possible that the cross-sectional positioning of the connector beams varies.

In most applications, the end result is a symmetrical one relative to the center-line of the guide rail cross section. For example, when the arrangement is viewed in the direction of the guide rail length, the position of the connector beams can alternate on both sides of the center-line of the guide rail cross section. By a center-line of the guide rail cross section is herein meant the line that crosses the center of both guide rail cross sections. It is possible that the connector beams are mounted on more than two positions around the center-line of the guide rail cross section. Having more than one position for the connector beams in relation to the center-line of the guide rail cross section might further rigidify the guide rail arrangement in more than one direction. This might be an advantageous solution in some applications of the current guide rail arrangement.

In many embodiments, the connector beams are positioned one after another, when viewed from the side. However, if the connector beams are mounted on more than one positions relative to the center-line of the guide rail cross section, it is possible that the connector beams cross. In one embodiment, at least two connector beams cross each other. For example, a connector beam can cross with both the adjacent connector beams. By crossing of the connector beams is herein meant that the two connector beams are substantially on the same plane and they make contact at the crossing point. By crossing is additionally meant that the projections of the connector beams on a plane cross. Geometrically speaking, the connector beams would behave like skew lines.

It is possible that the connector beams cross in the direction perpendicular to the length of the guide rail. In other words, the connector beams cross when viewed along the direction of the guide rails. In most such cases, the positions of the two ends of the connector beam relative to the center-line of the guide rail cross sections are opposite in two connector beams.

It is possible that the connector beams cross in the direction along the length of the guide rail. In other words, the connector beams cross when viewed from the side of the guide rail arrangement.

It is possible that the connector beams cross in the direction perpendicular to the length of the guide rail and in the direction along the length of the guide rail.

In one embodiment, at least two connector beams extend in a parallel direction. It is possible to construct the guide rail arrangement according to the present disclosure so that at least some connector beams are parallel to each other. For example, every other connector beam can extend in a parallel direction. The direction of the rest of the connector beams can be parallel in another direction, organized through another pattern or random. Every third connector beam may extend in a parallel direction. For example, if the connector beams extend along the center-line of the guide rail cross section, every third connector beam can be at a right angle relative to the length of the guide rails and the two connector beams between the parallel connector beams may be positioned at one or more different angles.

In one embodiment, the connector beams extend in at least two different angles relative to the length of each guide rail. By the angle of a connector beam relative to the length of the guide rail is herein meant the angle of the connector beam viewed from the side. The angle can vary between approximately 10° and 90°. The angle can be, for example, 30° to 45°. The angle can be, for example, 60° to 75°. In one embodiment, at least two of the connector beams extend at an angle of 90° relative to the length of both guide rails and at least two of the connector beams extend at an at least one angle smaller than 90° relative to the length of both guide rails. The angle is measured as the smaller angle relative to the guide rail. In other words, the angle is an acute angle. The suitable angle(s) can be selected by the skilled person based on the specifics of the guide rail arrangement. In a guide rail arrangement according to the present disclosure, it is thus possible that some connector beams extend at a first angle relative to the length of the guide rails and some connector beams extend at a second angle relative to the length of the guide rails. It is further possible that there are some connector beams that extend at a third angle. Also further angles, such as a fourth or a fifth angle are possible within one guide rail arrangement. The degree of each angle can be selected independently. The first angle can be 90°, while the further angles can be, for example 20° to 80°.

If the connector beams are located in the middle of the cross-sectional profile of the guide rails, they extend along the center-line of the guide rail cross section. The connector beams can run parallel to the center-line of the guide rail cross section in situations where their ends are on either side of said center-line, if the distance of both ends of a given connector beam to said center-line is the same. Alternatively, the connector beams may extend at an angle relative to the center-line of the guide rail cross section. The possible angles of the connector beams in this direction depend on the width of the guide rails as well as the distance between the guide rails. Such an angle can be, for example 20° to 60°. In situations where the connector beam is not parallel to the center-line of the guide rail cross section (i.e. is at an angle), the connector beams may cross to form a symmetrically supporting structure.

In one embodiment, the angle of the connector beams relative to the length of both guide rails is the same and other than 90°. Such a structure could comprise a plurality of connector beams extending in a parallel direction. It could alternatively produce a “zigzag” pattern. The connector beams can cross each other or the ends of adjacent connector beams can be substantially at the same position. Alternatively, there may remain distance between adjacent connector beams.

In one embodiment, at least one of the connector beams is made of profiled steel and has an I-profile. The I-profile can alternatively be termed an H-profile or a double-T-profile. The connector beam can have a flat profile. The connector beam can have an L-profile. The connector beam can have a U-profile. It is also possible that the connector beam has a solid circular profile or a hollow circular profile. It is also possible that the connector beam has a solid square or rectangular profile or a hollow square or rectangular profile. Also a C-profile is possible. The profile depends on the specifics of the application, such as distance between the parts, the magnitude of tensions etc. Thus, the skilled person is able to select a suitable profile.

The connector beams can be made of steel. It is possible to use metal alloys and/or composite materials or their combinations for manufacturing the connector beams.

In one embodiment, the ends of the connector beams are welded to the guide rails. Alternatively, the connector beams can be fastened to the guide rails through bolts passing corresponding openings in the guide rails and connector beams. It is thus possible that the guide rails comprise structures corresponding to the connector beams to mediate the attachment of the connector beams to the guide rails.

Further, it is possible that the connector beams are attached to the guide rails through nails. In such a case, openings may be absent from the guide rails and connector beams prior to the attachment of the connector beam to the guide rail. The ends of the connector beams may comprise means for bolt-fastening. The ends of the connector beams may comprise means for nail-fastening. The ends of the connector beams can be designed to allow easy and strong attachment to the guide rail. For example, the ends can be bent to a pre-determined angle for efficient positioning and attachment. A separate element, such as a plate, can be attached to the ends of the connector beams to mediate the fastening of the connector beams to the guide rails.

The connection between a guide rail and a connector beam can allow the adjustment of the relative position of the connector beam to the guide rail. The adjustability of the connection may allow adjusting the angle between the guide rail and the connector beam after the guide rail arrangement has been completed. The adjustability of the connection may allow adjusting the position of the connector beam along the guide rail after the guide rail arrangement has been completed.

In one embodiment, the guide rails have a T-profile and the guide rails are positioned back-to-back. By a back-to-back positioning is herein meant that the blades (also termed webs) of the guide rails, along which the elevator car or the counterweight moves, point away from each other. The connector beams are fastened to the flange of the guide rails on the side further away from the blade. In many embodiments, the connector beams are attached to the middle of the flange. In other words, the connector beams would extend along the center-line of the guide rail cross section. It is possible to mount the connector beams on either side of the middle of the flange, especially if the connector beams cross. The feasibility of such a configuration depends on the width of the flange relative to the width of the connector beam, among other things.

The higher the building, the more elevator capacity is typically needed. The most cost-efficient solution is often to construct more than one elevator in a common elevator shaft. In one embodiment, the elevator shaft is configured for at least three elevators. The elevator shaft can be configured for two elevators. The elevator shaft can be configured for four or more elevators. When there are two elevators in a common elevator shaft, one guide rail arrangement according to the present disclosure can be built between the elevator car guide rails. When there are three elevators in an elevator shaft, one of them can have a guide rail arrangement according to the present disclosure on its both sides. With four elevators, there are two such elevators, and so forth. If the elevators are equipped with a counterweight, the same reasoning applies to their guide rails, if a guide rail arrangement according to the present disclosure is used for the counterweights.

The current guide rail arrangement can be especially well suited for elevators in high-rise buildings, in which the completed guide rails can be hundreds of meters in length. In such buildings, shuttle elevators can be used. Thus, the distance between two landings can be more than one floor of the building, since shuttle elevators by-pass at least some floors. For example, if the completed guide rails are at least 50 meters in length, the current guide rail arrangement may be advantageous. It is also possible that the completed guide rails are at least 100 meters, 150 meters or 250 meters in length. Even longer guide rails are likely to become more common, and the current guide rail arrangement can be suited for such elevators. In one embodiment, the completed guide rails are at least 100 m, or at least 150 m, or at least 250 m in length.

Especially in high-rise buildings it is often desired that one elevator car has as high a hoisting distance as possible (i.e. the vertical moving range of an elevator car would be as large as possible). The higher the hoisting distance is, the longer the completed guide rail needs to be. The weight of the guide rail being proportional to its length, the need to optimize the material usage is most pressing in elevators with a long hoisting distance. At the same time, long guide rails might be more prone to bending and other distortions, so they need to be constructed sufficiently rigid. This again is achieved by constructing thick guide rails that are heavy.

Further, the guide rail sections forming the guide rail need to be accurately positioned next to each other to avoid jerking of the elevator car when it moves over a junction between two guide rail sections (i.e. the position at which the ends of two guide rail sections meet). The heavier the individual guide rail sections are, the more difficult the accurate installation and aligning of the guide rail sections is. Therefore, it might be advantageous to be able to use lighter guide rail sections.

In one aspect, a method for installing guide rails in an elevator shaft is disclosed. The method comprises the steps of

a) assembling two guide rails guiding the movement of an elevator car or a counterweight, each guide rail guiding the movement of a different elevator car or counterweight; and

b) aligning each guide rail. The method is characterized in that the method further comprises the step of

c) connecting said guide rails through connecting beams having two ends so that each end is attached to one guide rail for connecting the guide rails to each other and for rigidifying the guide rails.

In step a), the assembly of guide rails takes place through methods known in the art. In short, the guide rail sections are brought to the elevator shaft and mounted on the walls or on the dividing beams starting from the bottom-most guide rails. The dividing beams can be pre-mounted in the elevator shaft or they can be mounted as the guide rail assembly progresses. After at least some guide rail sections are assembled into a guide rail, the guide rails are aligned at step b) to ascertain their correct orientation and preliminary straightness. By aligning guide rails is herein meant the adjustment of guide rail section orientation through the fastening means, such as brackets, so that it approximately matches the intended direction of the guide rail. The shape and direction of the guide rail sections can subsequently be finalized by shimming.

The method according to the present disclosure is characterized in that after the guide rails are aligned, connecting beams are used to connect two adjacent guide rails to each other at step c). This results in the formation of a guide rail arrangement in which two guide rails belonging to different elevators form a common structure. The connector beams rigidify the guide rails so that they do not bend as easily as without the connector beams. As detailed above, the connector beams can be attached to the guide rails in many different orientations. The most beneficial arrangements are likely to be ones, in which not all connector beams are parallel to each other. The angle of all the connector beams relative to the guide rails can be the same even if the conbeams are not parallel, since the angle is counted as the smaller angle relative to the length of the guide rails.

In some embodiments, the attachment between the connector beams and guide rails is finalized after the guide rails have been aligned. The connector beams can be present between two guide rails already before the alignment process has been finished. However, the can be, for example loosely attached to each guide rail, thus not connecting the two guide rails in the meaning of the current disclosure.

Further, it is possible to pre-assemble at least some of the components of the current guide rail arrangement. For example, the connector beams can be loosely attached to guide rail sections already before the guide rail sections are installed. Pre-assembling at least some of the components of the guide rail arrangement according to the present disclosure can take place at the installation site or at a workshop. The rigidifying of the structure is performed during or after the installation work.

When two connector beams are substantially on the same plane and they cross, they may be attached to each other at the crossing point. In such a case, embodiments of the method according to the present disclosure can be envisaged, in which two connector beams are attached to each other, through, for example, welding, bolts or nails. The two connector beams can be attached to each other prior to attaching to the guide rails, at the same time or afterwards.

Different steps of the method according to the present disclosure can be contemporaneously performed on several heights along the length of given two guide rails. The work lower along the guide rails may have progressed to step c) while at a higher level, step b) is being performed. Further up, step a) might be simultaneously ongoing.

In one embodiment, the guide rails are assembled with the aid of dividing beams. The guide rails can be attached to dividing beams during assembly (i.e. at step a) of the method), after which the guide rails are aligned at step b). It is possible, that a lower number of dividing beams is designed and mounted in the elevator shaft compared to prior art solution, as connecting the guide rails at step c) rigidifies the guide rail assembly.

In one aspect an elevator arrangement is disclosed. The elevator arrangement is characterized in that it comprises at least one guide rail arrangement according to the current disclosure.

By an elevator arrangement is herein meant a system comprising more than one elevator in an elevator shaft. The functioning of the elevators in the elevator arrangement is optionally coordinated.

### DESCRIPTION OF DRAWINGS

The following figures are to be understood as exemplary embodiments of the material transport arrangement according to the present disclosure. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described below may also be employed without departing from the scope of the invention, which is defined in the accompanying claims.

There are various controlling and safety devices associated with the guide rail arrangement according to the present disclosure, but all of them have been omitted from the figures for clarity and any conventional methods can be used for their design. All parts of the guide rail arrangement according to the present disclosure are depicted only schematically and their sizes are not drawn proportionally unless otherwise indicated. Further, all additional elevator components are omitted from the figures, although some of them might be present simultaneously with the current guide rail arrangement.

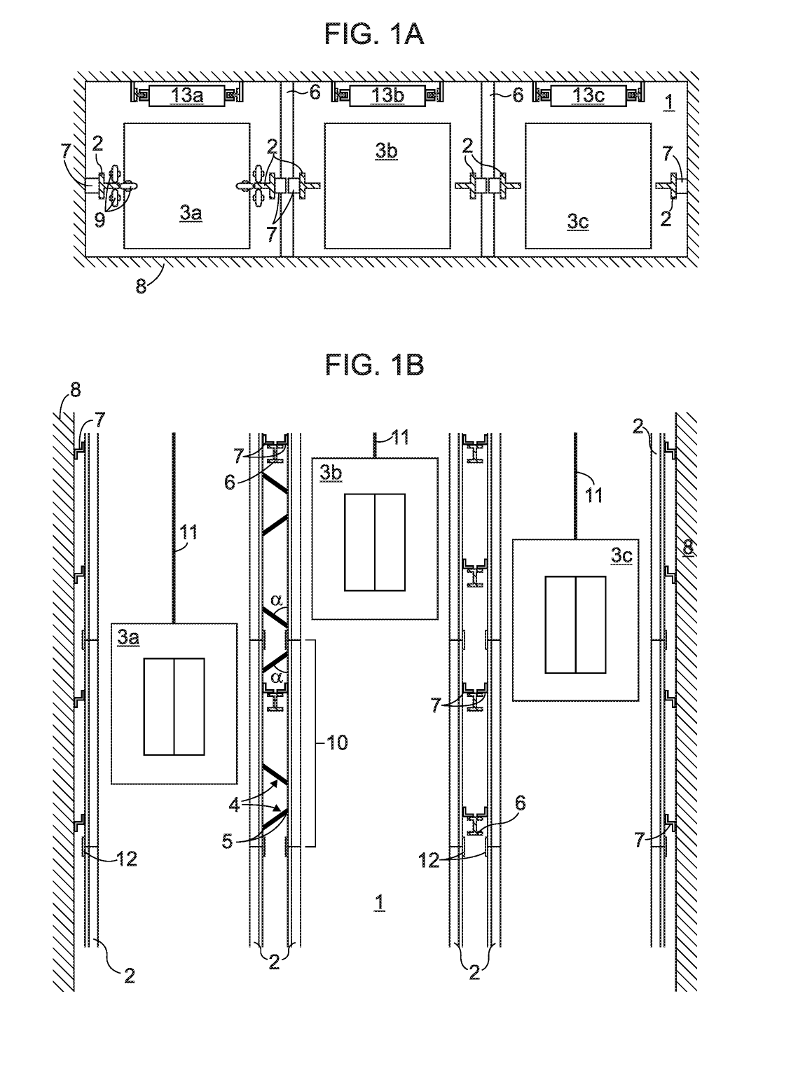

FIG. 1A is a schematic cross-sectional view of an elevator shaft 1 comprising three elevators. The elevator shaft 1 is surrounded by an elevator shaft wall 8. Elevator shaft landing entrances, i.e. openings in the elevator shaft wall 8 for moving passengers and/or cargo between the elevator car 3 and the elevator landing, are not depicted. The counterweight 13 for each elevator car 3a, 3h, 3c is shown attached to the elevator shaft wall 8 with a conventional guide rail arrangement. The position of the counterweight 13, as well as the location of its guide rails can vary depending on the optimal layout of the elevator components in the elevator shaft 1. FIG. 1A illustrates only the general layout of an elevator shaft 1. Therefore, the connector beams 4 according to the present disclosure have been omitted from FIG. 1A.

For each elevator, an elevator car 3a, 3b, 3c is shown. All details of equipment relating to the movement of the elevator car 3a, 3b, 3c have been omitted from the figure for clarity. Elevator car guide rails 2 are presented, one on each side of the elevator car 3a, 3b, 3c. The elevator car 3a, 3b, 3c moves along the guide rails 2 with the aid of guide rollers 9 or guide shoes that mediate the contact between the elevator car 3a, 3b, 3c and the guide rail 2. The guide rails 2 have a T-profile. The guide rollers 9 move along the web portion (the blade) of the guide rail 2. In FIG. 1A, only the left-most elevator car 3a is drawn with guide rollers 9, although each elevator car 3a, 3b, 3c is equipped with similar devices. Each guide rail 2 is attached to its position through brackets 7, located at predetermined vertical intervals in the elevator shaft 1. As FIG. 1A is a cross-sectional view, only one bracket 7 for each guide rail 2 is visible. The brackets 7 are constructed through methods known in the art. In FIG. 1A, the brackets 7 are attached to the flange of the guide rails 2, i.e. on the side facing away from the elevator car 3 moving along the guide rail 2 in question.

On the wall 8 side of the elevator cars 3a and 3c, the brackets 7 are fastened to the elevator shaft wall 8. The guide rails 2 between elevator cars 3a and 3b, and between elevator cars 3b and 3c are attached to dividing beams 6 through the brackets 7. Each dividing beam 6 has two ends and each end is attached to the wall 8. In FIG. 1A the wall 8 is a solid wall made, for example of concrete and/or steel. However, it is possible that the wall 8 is partially open. The wall 8 can alternatively be a scaffold made of steel, for example. In such a case, the material and structure of the dividing beams 6 can be same or similar as for the scaffold. The dividing beams 6 are attached to the wall 8 through methods known in the art, which depend on the design and material of both the wall 8 and the dividing beams 6. In the embodiment of FIG. 1A, the dividing beams 6 have an I-profile. Other profile alternatives are known in the art and may be used in some embodiments. The brackets 7 are attached to the flange portions of the dividing beams 6. All details of the bracket 7 attachment to the wall 8 or dividing beams 6 are omitted, as they are known to the skilled person.

FIG. 1B depicts an embodiment according to the present disclosure from one side. Three elevator cars 3a, 3b, 3c move in an elevator shaft 1. Elevator shaft walls 8 are depicted on both sides of the elevator shaft 1. In FIG. 1B, the hoisting rope 11 of each elevator car 3 has been depicted, but all other equipment, including the guide rollers 9 or guide shoes has been omitted. In the embodiment of FIG. 1B, the guide rails 2 of the elevator cars 3 are visible from the side. In this viewing direction, also the fishplates 12 connecting the guide rail sections 10 to each other are schematically shown. The guide rails 2 have a T-profile. As in FIG. 1A, the wall-most guide rails 2 of elevator cars 3a and 3c are attached to the wall 8 through brackets 7. The guide rails 2 between elevator cars 3a and 3b, and between elevator cars 3b and 3c are attached to dividing beams 6 through brackets 7. A plurality of dividing beams 6 is shown connecting the guide rails 2 between the elevator cars 3a, 3b, 3c. The I-profile of the dividing beams 6 is visible. All details of the bracket 7 attachment to the wall 8 or dividing beams 6 are omitted.

The connector beams 4 according to the present disclosure are visible in the elevator arrangement of FIG. 1B. In order to highlight them, they are drawn as solid black lines. In practice, the thickness, cross-sectional profile and material of the connector beams 4 may vary.

In the embodiment of FIG. 1B, the connector beams 4 are drawn only between the guide rails 2 located between the elevator cars 3a and 3b. In most applications, the connector beams 4 are located between all adjacent guide rails 2. In other words, in most elevator installations, also the guide rails 2 between elevator cars 3b and 3c would be connected by connector beams 4.

In FIG. 1B, the interval of dividing beams 6 is smaller between the guide rails 2 that are not connected by connector beams 4. Similarly, the interval of brackets 7 connecting the guide rail 2 to the wall 8 is approximately the same as the number of dividing beams 6 for the guide rails 2 not connected by the connector beams 4. This is to allow the use of guide rails 2 of similar rigidity on both sides of each elevator car 3a, 3b, 3c. The interval of the brackets 7 attaching the guide rails 2 to the wall 8 can thus be adjusted so that a guide rail 2 of similar rigidity can be used on both sides of a given sidemost elevator car 3a, 3c of an elevator shaft 1, also in when the connector beams 4 according to the present disclosure are used.

Alternatively, it is possible that the guide rails 2 attached to the wall 8 are structurally different from the ones located between two elevator cars 3. For example, the flange portion can be thicker or comprise rigidifying structures.

Each connector beam 4 in FIG. 1B comprises two ends 5. Each end 5 is attached to one guide rail 2. The two guide rails 2 are connected to each other through the connector beams 4. Each of the two guide rails 2 connected by the connector beams 4 is guiding the movement of a different elevator car 3. For FIG. 1B, one of the guide rails 2 thus guides the movement of elevator car 3a and the other guide rail 2 guides the movement of elevator car 3b. The two guide rails 2 and the connector beams 4 connecting them form a guide rail arrangement according to the present disclosure.

The connector beams 4 are positioned along the length of the guide rails 2. This means that there are several connector beams 4 distributed on different vertical levels along the guide rails 2. The connector beams 4 are typically, but not necessarily, positioned along a substantial portion of the guide rail 2 length. It is possible that there are fewer connector beams 4 at the top and/or bottom of the guide rails 2. There might be some areas of the guide rails 2 from which the connector beams 4 are absent.

In FIG. 1B, all the connector beams 4 have the same angle (α) relative to the guide rails 2. In other words, all the connector beams 4 extend at the same angle relative to the length of the guide rails 2. The angle is approximately 55°. However, they are not all parallel in the same direction. The connector beams 4 are symmetrically positioned so that every other connector beam 4 is parallel in the same direction. In other words, at least some connector beams 4 extend in a parallel direction. More specifically, in this embodiment, all of the connector beams 4 extend in a parallel direction. There are two directions in which the connector beams 4 are parallel. In some embodiments, there could be, for example three directions in which the connector beams 4 are parallel. In some embodiments, there could be, for example four, five or more directions in which the connector beams 4 are parallel.

In this embodiment, the connector beams 4 are grouped. In each group, there are two connector beams 4 that extend in different directions. The directions of the two connector beams 4 in each group are identical. The distance between two groups varies. In FIG. 1B it can be seen that the distance between the bottom-most group and the middle group is larger than between the top-most group and the middle group. The positioning of the connector beams 4 can be adjusted, for example, taking the interval of dividing beams 6 and/or the length of individual guide rail sections 10 into account.

In the embodiment of FIG. 1B, the connector beams 4 are attached to the flange portion of the guide rails 2. The guide rails 2 have a T-profile and the guide rails 2 of neighboring elevators are positioned back-to-back.

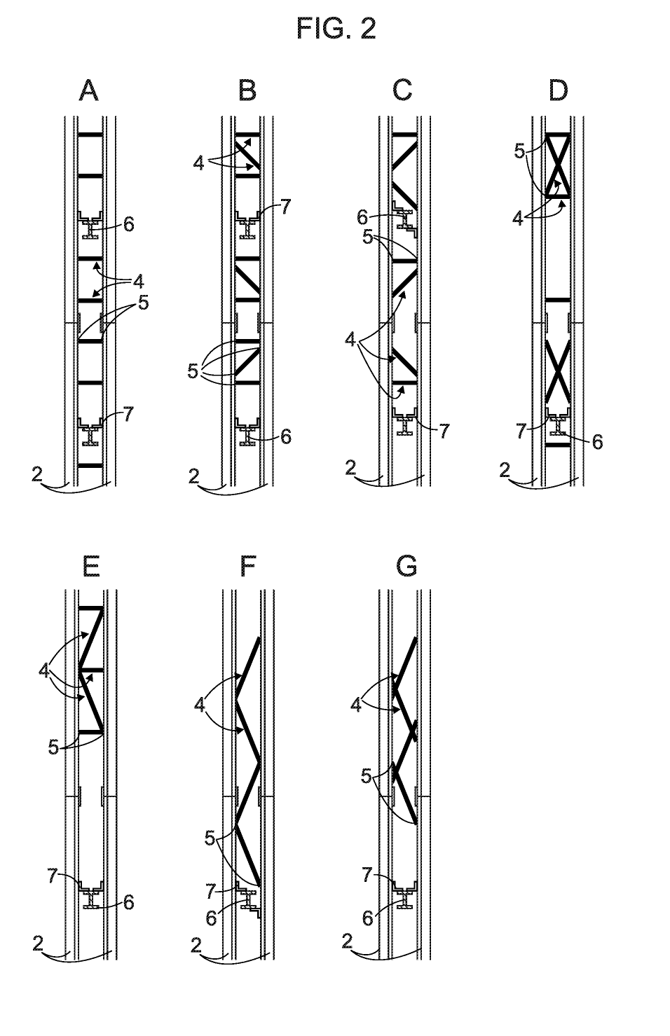

FIG. 2, panels A-G, depicts embodiments of the current guide rail arrangement seen from one side. The viewing direction is the same as in FIG. 1B, but only one example of a guide rail arrangement is shown in each panel and all other details of the elevator shaft are omitted. The connector beams 4 are drawn similarly to FIG. 1B. In each panel, at least one dividing beam 6 with brackets 7 attaching the guide rails 2 to the dividing beam 6 is shown.

Panel A shows an embodiment in which the two guide rails 2 are connected by a plurality of horizontal connector beams 4. The angle of all connector beams 4 relative to the length of the guide rails 2 is 90°. All connector beams 4 may be parallel. However, it is possible that at least some connector beams 4 extend in a direction other than the center-line of the guide rail 2 cross section. In such a case there may be more than one direction in which the connector beams 4 extend in parallel. Typically, all connector beams 4 extend along the center-line of the guide rail 2 cross section. In other words, they are attached to the middle of the flange portion of each guide rail 2.

The connector beams 4 are positioned at approximately equal vertical intervals. The connector beams 4 are positioned so that the distance between the dividing beams 6 to each connector beam 4 on each side of the dividing beam 6 is approximately the same as the distance between two connector beams 4.

Panel B shows an embodiment in which the connector beams 4 are grouped. In each group, there are two horizontal connector beams 4, between which a connector beam 4 at an angle smaller than 90° relative to the length of the guide rails 2 is positioned. In this embodiment, the angle of the middle connector beam 4 is 45°. The connector beams 4 within a group are close to each other. In other words, the distance between the connector beams 4 within a group is smaller than the distance between the two closest connector beams 4 of different groups. The adjacent connector beams 4 within a group do not touch each other. Thus, the connector beams 4 are positioned at a distance from each other.

In this embodiment, there are three directions in which the connector beams 4 extend. All connector beams extend along the center-line of the guide rail 2 cross section. All the horizontal connector beams 4 extend in a parallel direction. Two connector beams 4 extend in a parallel direction, whereas the middle connector beam 4 of the lowest group extends in a third direction.

Thus, from the embodiment of panel B, it is evident that not all groups of connector beams 4 need to be identical. Further, the distance between groups can vary.

If all the connector beams 4 of panel B would not extend along the center-line of the guide rail 2 cross section, it could be envisaged that, for example, the middle connector beams 4 of the two lower groups would cross. In other words, the two ends 5 of each of these connector beams 4 would be positioned on opposite sides of the center-line of the guide rail 2 cross section.

Further, it would be possible that there would be more than one horizontal connector beam 4 extending in a parallel direction. Each of them could be off-set from the center-line of the guide rail 2 cross section.

Panel C shows an embodiment in which there are horizontal cross beams 4, between which two symmetrically angled connector beams 4 with an angle smaller than 90° are present. The connector beams 4 are organized at differing intervals. Groups of different geometry can thus be combined in an arrangement according to the present disclosure.

In the embodiment of panel D, there are two groups of connector beams 4. In the upper group, the adjacent connector beams 4 are in contact with each other from their ends 5. They extend along the centerline of the guide rail 2 cross section. Two of the connector beams 4 cross and they can be attached to each other at the crossing point. The attachment can take place before or after attaching the connector beams 4 to the guide rails 2.

If the connector beams 4 would not extend along the center-line of the guide rail 2 cross section, it could be envisaged that the horizontal connector beams 4 would be symmetrically off-set from said center-line on its opposite sides. The crossing connector beams 4 could cross in the direction perpendicular to the length of the guide rail 2 and in the direction along the length of the guide rail 2.

Although in most embodiments, all the groups within a guide rail arrangement according to the present disclosure are identically, or at least similarly, organized, it is not necessary. Panel D depicts an example of taking the position of the junction between the ends of two guide rail sections 10 into account when designing the positions of the connector beams 4. In the lower group, the horizontal connector beams 4 have been positioned at a distance from the crossing connector beams 4 to leave space for a junction and for a dividing beam 6. It could be possible to omit the lowermost connector beam 4 in panel D if the dividing beam 6 lends sufficient support to the guide rails 2 at the relevant position.

Panel E shows an embodiment in which a group of connector beams 4 comprises three horizontal connector beams 4 with oblique connector beams 4 in between. The oblique connector beams 4 are at the same angle relative to the guide rails 2, but extend in different directions. The ends 5 of the adjacent connector beams 4 are substantially in the same position. The ends 5 can optionally be attached to each other in addition to being attached to the guide rails 2. A guide rail arrangement according to the present disclosure would typically comprise a number of groups repeated, but only one is depicted in panel E.

Panel F shows an embodiment in which the connector beams 4 form a “zigzag” pattern. The ends 5 of adjacent connector beams 4 are attached to the same position along each guide rail 2.

Panel G shows an embodiment similar to that of panel F, but in which the connector beams 4 cross. In the embodiment of panel G, the connector beams 4 cross relatively close to their ends 5. It is, however, that they cross closer to the middle point between the guide rails 2 or at the middle point. In this viewing direction, only crossing in the direction along the guide rail 2 length in visible. However, the connector beams 4 may cross also in the direction perpendicular to the guide rail 2 length.

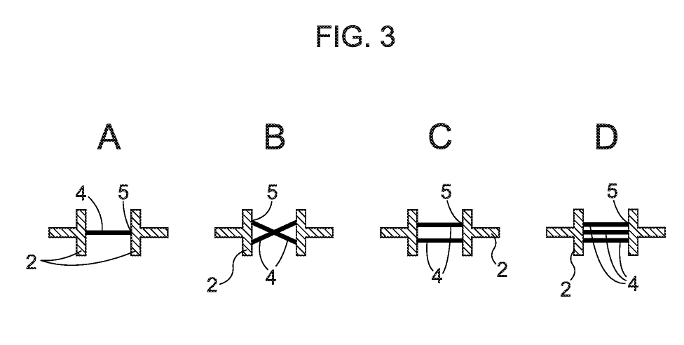

FIG. 3, panels A-D visualizes some embodiments of the orientation of the cross beams on a plane perpendicular to the guide rail 2 length. Dividing beams, brackets and the fishplates are not shown in FIG. 3.

In panel A, the connector beam 4 extends along the center-line of the guide rail 2 cross section. Both ends 5 of the connector beam 4 are positioned at the middle point of the guide rail 2 flange portion. The guide rails 2 are positioned back-to-back.

In panel B, the connector beams 4 cross in the plane perpendicular to the guide rail 2 length. In other words, each end 5 of a connector beam 4 is attached to the guide rail 2 at a distance from the center-line of the guide rail 2 cross section on its opposing sides. The connector beams 4 depicted in panel B are symmetrically positioned relative to the centerline of the guide rail 2 cross section.

In panel C, there are two connector beams 4 visible between the guide rails 2. Each connector beam 4 is positioned off-set relative to the center-line of the guide rail 2 cross section.

In panel D, three connector beams 4 are visible. Two of them are off-set relative to the centerline of the guide rail 2 cross section, as in panel C. The third connector beam 4 extends along the centerline of the guide rail 2 cross section.

The angle of the connector beams 4 relative to the length of the guide rails 2, or their relative heights, are not visible in this schematic presentation. For example, the connector beams 4 furthest away from the middle point of the flange can extend at a right angle relative to the length of the guide rails 2. The connector beam 4 positioned between the two can extend in any other direction. Alternatively, the middle connector beam 4 may extend horizontally, and the two further from the flange middle point can extend in another angle, possibly in opposite directions. Further, it is possible that all the connector beams 4 visible in panel D extend at a right angle relative to the guide rail 2 length. Alternatively, all of them can have a smaller angle than 90° relative to the length of the guide rail 2.

1. A guide rail arrangement for an elevator shaft comprising:
two guide rails guiding movement of an elevator car or a counterweight, each guide rail guiding the movement of a different elevator car or counterweight; and
a plurality of connector beams connecting the guide rails to each other, the plurality of connector beams being positioned along a length of the guide rails, and each of the plurality of connector beams having two ends,
wherein each end of each of the plurality of connector beams is attached to one guide rail for connecting the guide rails to each other and for rigidifying the guide rails.

2. The guide rail arrangement according to claim 1, wherein at least two connector beams extend in a parallel direction.

3. The guide rail arrangement according to claim 1, wherein the connector beams extend in at least two different angles relative to the length of each guide rail.

4. The guide rail arrangement according to claim 1, wherein the angle of the connector beams relative to the length of both guide rails is the same and other than 90°.

5. The guide rail arrangement according to claim 1, wherein at least two of the connector beams extend at an angle of 90° relative to the length of both guide rails and at least two of the connector beams extend at at least one angle smaller than 90° relative to the length of both guide rails.

6. The guide rail arrangement according to claim 1, wherein at least two connector beams cross each other.

7. The guide rail arrangement according to claim 1, wherein at least one of the connector beams is made of profiled steel and has an I-profile.

8. The guide rail arrangement according to claim 1, wherein the ends of the connector beams are welded to the guide rails.

9. The guide rail arrangement according to claim 1, wherein the guide rails have a T-profile and the guide rails are positioned back-to-back.

10. The guide rail arrangement according to claim 1, wherein the elevator shaft is configured for at least three elevators.

11. The guide rail arrangement according to claim 1, wherein the completed guide rails are at least 100 m in length.

12. A method for installing guide rails in an elevator shaft comprising the steps of:
a) assembling two guide rails guiding the movement of an elevator car or a counterweight, each guide rail guiding the movement of a different elevator car or counterweight;
b) aligning each guide rail; and
c) connecting said guide rails through connecting beams having two ends so that each end is attached to one guide rail for connecting the guide rails to each other and for rigidifying the guide rails.

13. The method according to claim 12, wherein the guide rails are assembled with the aid of dividing beams.

14. An elevator arrangement, comprising at least one guide rail arrangement according to claim 1.

15. The guide rail arrangement according to claim 1, wherein the completed guide rails are at least 150 m in length.

16. The guide rail arrangement according to claim 1, wherein the completed guide rails are at least 250 m in length.

17. The guide rail arrangement according to claim 2, wherein the connector beams extend in at least two different angles relative to the length of each guide rail.

18. The guide rail arrangement according to claim 2, wherein the angle of the connector beams relative to the length of both guide rails is the same and other than 90°.

19. The guide rail arrangement according to claim 2, wherein at least two of the connector beams extend at an angle of 90° relative to the length of both guide rails and at least two of the connector beams extend at at least one angle smaller than 90° relative to the length of both guide rails.

20. The guide rail arrangement according to claim 3, wherein at least two of the connector beams extend at an angle of 90° relative to the length of both guide rails and at least two of the connector beams extend at at least one angle smaller than 90° relative to the length of both guide rails.
